(19) United States
(12) Patent Application Publication
(10) Pub. No.: US 2007/0101687 A1
(43) Pub. Date: May 10, 2007

(54) Horse jock support for the flaccid or erect penis of a stallion (horse) that is being treated for paraphimosis

(76) Inventor: James William Draper, Bethlehem, GA (US)

Correspondence Address: James William Draper Jr., 1040 Monroe Hwy, Bethlehem, GA, 30620, US

(21) Appl. No.: 11/266,671

(22) Filed: Nov. 4, 2005

(51) Int. Cl. B68B 1/00

(52) U.S. Cl. 54/1

(57) ABSTRACT

The Horse Jock is a devise made of various types of fabric that will provide support for the exposed flaccid penis of a male horse, while the stallion is being treated for paraphimosis. Presently there is no known technical devise that supports the exposed flaccid penis of the stallion while it is being treated for condition. Currently and generally a “home-made” type of support, such as a bed sheet, is used to support the penis while it is being treated. The Horse Jock is much more feasible, more practical and far less unpleasant than the bed sheet method that is typically currently being used.

Mr. James William Draper Jr., a natural-born US citizen, residing at 1040 Monroe Hwy, Bethlehem, Ga. 30620, in February 2004, invented The Horse Jock support for the purpose of supporting the flaccid or erect penis of a stallion (horse) owned by him that was being treated for a condition known as paraphimosis. A PROVISIONAL APPLICATION FOR PATENT for The Horse Jock was submitted by James William Draper Jr. on Mar. 29, 2004.

The penis of a horse is musculocavernous, with double preputial folds, large mushroom-shaped glans comprising the collum glandis, corona and urethral process with a small urethral sinus. The penis of the stallion at rest lies withdrawn into the preputial sheath. It protrudes from the sheath for urination and during sexual activity. For urination, the penis usually protrudes much less then full length and remains flaccid. During sexual excitement, the penis becomes erect and reaches its full length. Afterwards urination or sexual excitement, the penis withdraws back into the sheath.

Paraphimosis is a condition in which after the penis protrudes from the sheath during urination or sexual excitement, it fails to withdraw back into the sheath due to inversion of the preputial orifice (see 10-FIG. 2 and 11-FIG. 3). This condition, if left untreated, can become painful to the stallion and can lead to infection of the penis, thus incapacitating the stallion's ability to urinate properly or engage in copulation. Treatment of the condition involves hydrotherapy and chemotherapy, during which time the exposed flaccid or erect penis must be supported. Supporting the exposed flaccid or erect penis relieves pain and allows the stallion to involve himself in typical daily activities without the threat of permanently damaging the penis, until the penis is naturally withdrawn into the sheath.

The Horse Jock is intended to provide support for the exposed flaccid or erect penis during the time the stallion is being treated for paraphimosis.

### CROSS-REFERENCE TO RELATED APPLICATION

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

On Dec. 19, 2003, I took my two year old paint stallion, Cheyenne, to the University of Georgia Veterinary Teaching Hospital on the recommendation of veterinarian who was treating Cheyenne, Dr. Kim Neff. Cheyenne was suffering from a condition called paraphimosis.

On Jan. 3, 2004 I took Cheyenne back to my home, where he was being housed, with instructions from the hospital to continue with the same type of treatment for the condition that the hospital had performed while the stallion was being treated by them: to treat the penis with hydrotherapy twice per week and to continually support the flaccid penis of a stallion with a bed sheet tied around his body, much like a sling.

On Jan. 17, 2004, after about two weeks of slinging the penis with bed sheet, as recommended by the hospital, I determined that there had to be a better way to accomplish the same results, than by using a bed sheet sling. The bed sheet sling was messy, unsanitary, troublesome and expensive to buy and to maintain. Therefore, I began to think of other options that I felt could work. My first idea was to use two pairs of pantyhose nylon stockings sewed together at the top. I placed the sewn top portion of the nylons on the horse's penis and then pulled two of the leg portions of the nylons between the horse's back legs and tied them together over his tail. The other two leg portions were then placed under the horse's body, between his front two legs and tied around his neck. This worked better than the bed sheet sling because the horse's urine could pass through the nylon unobstructed without the mess and subsequent washing associated with the bed sheet sling.

A few days afterwards, Feb. 1, 2004 I experimented with a XXX large size human Jockstrap. Of course it was not functional, but it did give me an idea for The Horse Jock.

On February 7, I determined that if I could take the effectiveness of the pantyhose method and somehow incorporate it into a jockstrap paradigm for horses, that I would have a workable solution. So, I began to investigate and search at some of the local merchandise stores for alternate materials that could be used for The Horse Jock.

On February 9, I took the various materials that I had found and purchased to a local fabric sewing industry. I explained to them what I wanted and they made for me my first prototype of The Horse Jock. On Feb. 13, 2004 I put The Horse Jock prototype on Cheyenne and let him wear it for one week. Although it worked as well as I had expected it to work, I still felt that some improvements were needed. It took another week for the improvements to be incorporated into the design. Afterwards, I fitted Cheyenne with the new horse jock, which seemed to work very well.

On February 18, I began to research how I could patent The Horse Jock and how best to get it into to hands of practicing veterinarians. Although this condition in horses is not as common as some other potentially harmful conditions that affects a horse's normal and natural lifestyle, it does occur often enough that veterinarians and veterinarian hospitals would readily welcome any device that would assist them as they treat the horse, while at the same time, help the horse by providing support for him while he is being treated. At the present time, I have found no other device that has been successfully used by veterinarians in their treatment of paraphimosis in horses.

### BRIEF SUMMARY OF THE INVENTION

The Horse Jock is a devise made of various types of fabric that is intended to provide support for the exposed flaccid penis of a male horse, while the stallion is being treated for paraphimosis. Paraphimosis is a condition in which after the penis protrudes from the sheath during urination or sexual excitement, it fails to withdraw back into the sheath due to inversion of the preputial orifice. Paraphimosis, if left untreated, can become painful to the horse and can lead to infection of the penis, thus incapacitating his ability to urinate properly or engage in copulation. Treatment of the condition usually involves hydrotherapy and chemotherapy, during which time the exposed erect penis must be supported. Supporting the stallion's exposed flaccid or erect penis relieves pain and allows him to involve himself in typical daily activities without the threat of permanently damaging the penis, until the time that the penis naturally withdraws itself into the sheath.

### BRIEF DESCRIPTION OF THE SEVERAL VIEWS OF THE DRAWING

FIG. 1: a plan view of the invention in a flat state, i.e. not wound around, looking at the face that will be exposed. The reverse side will rest on the horse.

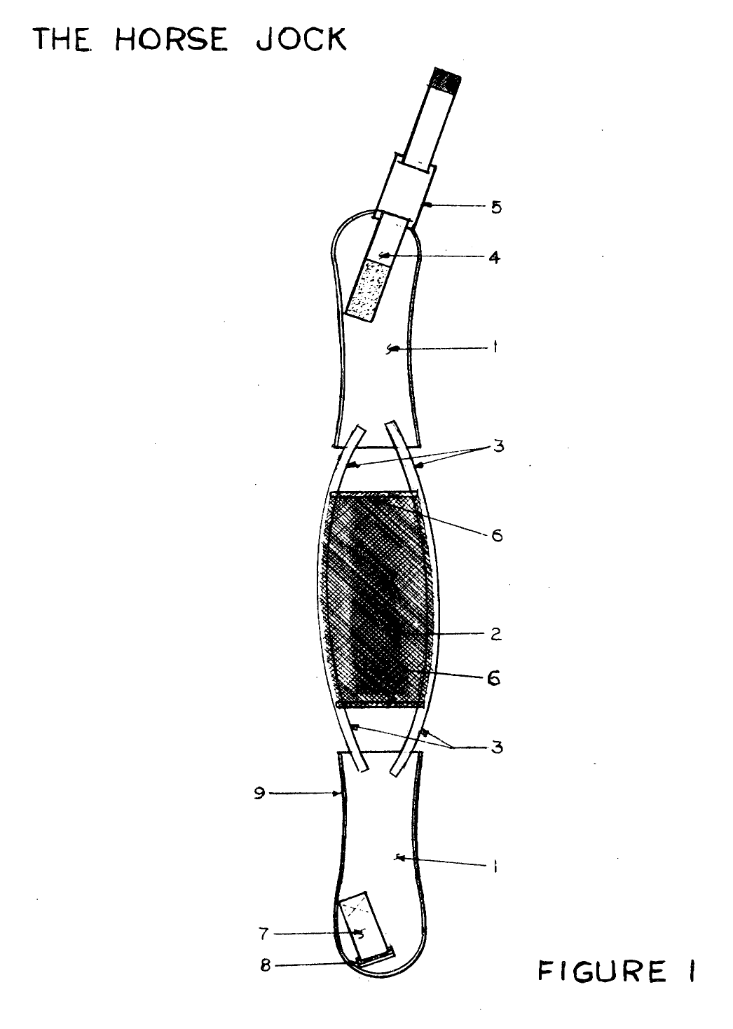

FIG. 2: an elevation view of the invention showing how the invention will function as a support for an exposed flaccid penis and how it will rest on the horse.

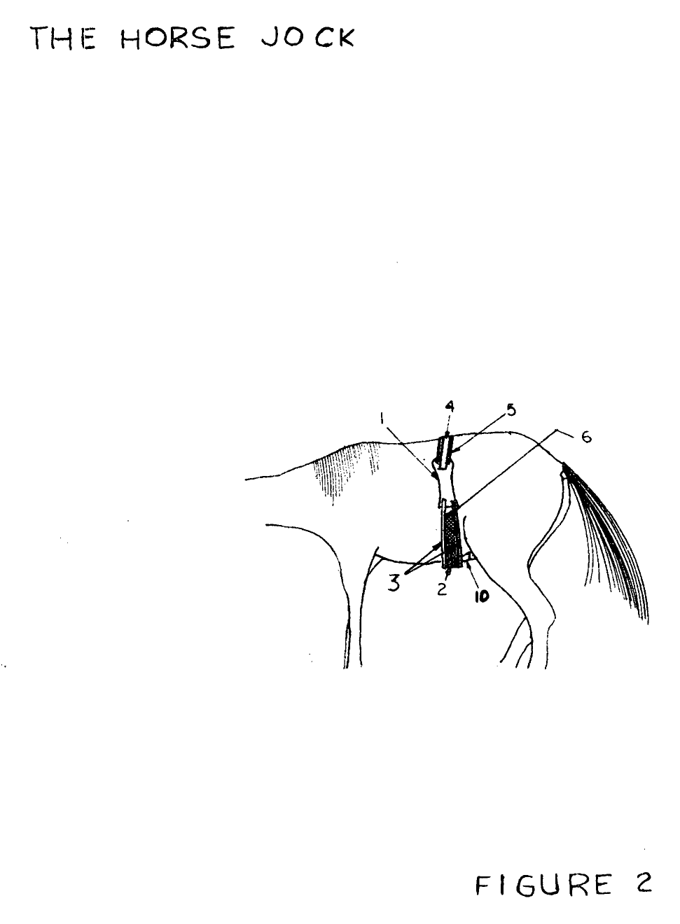

FIG. 3: an elevation view of the invention showing how the invention will function as a support for an erect penis and how it will rest on the horse.

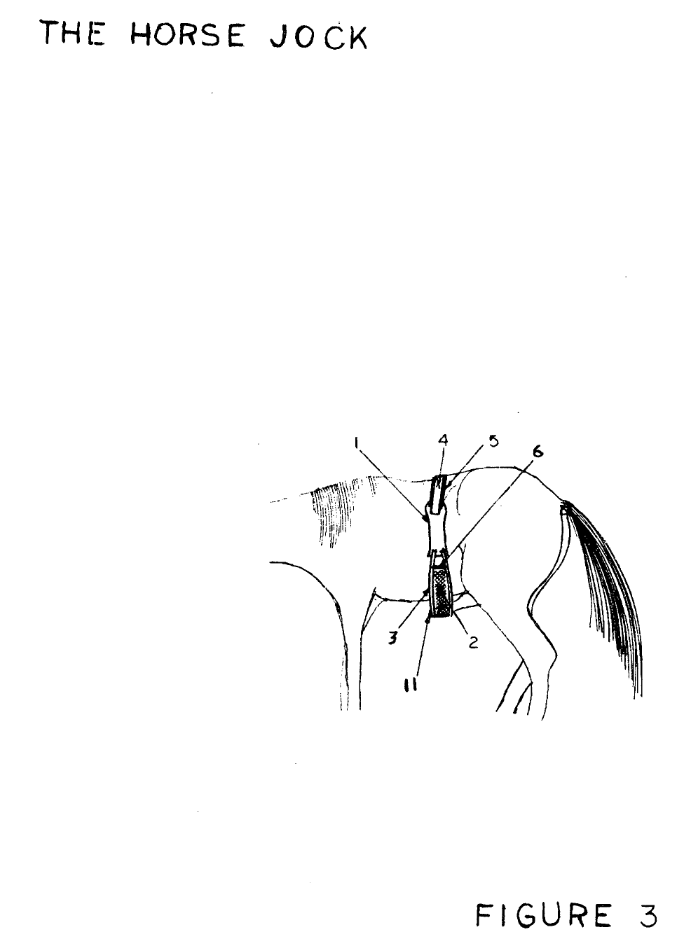

The reference numerals used in the drawings are designated as follows:
(1) 0.3125″ thick flexible fiber board material (or similar) covered with combed cotton cloth or similar material, on the side that will be next to the horse and nylon or similar material on the exposed side.
(2) Nylon or similar netting with holes not larger than 0.375″ in diameter.
(3) Two flexible elastic nylon (or equal) straps
(4) Nylon securing adjusting strap with Velcro fastening system on each end.
(5) Extra flexible pad that rest on the horse between his body and the securing strap.
(6) Two elastic nylon straps
(7) Nylon securing strap
(8) Plastic or nylon securing buckle.
(9) Seam material typical throughout stiffening pad 1
(10) Flaccid penis with paraphimosis
(11) Erect horse penis with paraphimosis

### DETAILED DESCRIPTION OF THE INVENTION

The Horse Jock is a devise made of various types of fabric that is intended to provide support for the exposed flaccid or erect penis of a male horse, while the stallion is being treated for paraphimosis. Paraphimosis is a condition in which after the penis protrudes from the sheath during urination or sexual excitement, it fails to withdraw back into the sheath due to inversion of the preputial orifice. Paraphimosis, if left untreated, can become painful to the horse and can lead to infection of the penis, thus incapacitating his ability to urinate properly or engage in copulation. Treatment of the condition usually involves hydrotherapy and chemotherapy, during which time the exposed flaccid or erect penis must be supported. Supporting the stallion's exposed flaccid or erect penis relieves pain and allows him to involve himself in typical daily activities without the threat of permanently damaging the penis, until the time that the penis naturally withdraws itself into the sheath. The Horse Jock is intended to support the flaccid or erect penis of the horse so that the chance of injury to the flaccid or erect penis is minimized while the stallion is being treated.

The embodiment of The Horse Jock has two preferably one-piece flexible stiffening pads 1, which is constructed of flexible fiber board material (at least 0.3125″ thick) covered on the exposed side with nylon or nylon type material and on the side that will be next to the horse's body with combed cotton or soft combed-type fabric material. These stiffening pads 1 will be at least 4″ in width and at least 18″ in length. Between the two stiffening pads 1, are two flexible elastic nylon (or equal) straps 3 that connect to each of the stiffening pads 1. These straps 3 will be at least 2″ wide and at least 25″ in length. They will overlap the stiffening pads by at least 4″ and will be sewn to the stiffening pads 1. Sewn perpendicular to the elastic nylon straps 3 are two, elastic nylon (or equal) straps 6. These straps will be at least 0.5″ wide and at least 6″ long. They will overlap nylon straps 3 by at least 1″ on each side and will be sewn to straps 3. Elastic nylon straps 6 will be sewn in place at approximately 6″ from the end of stiffening pads 1 (typical both ends). Sewn to the straps 3 and to straps 6 is medium to heavy weight nylon or nylon type netting 2, with netting holes no larger than 0.375″ in diameter. The nylon or nylon type netting 2 will be at least 10″ in width and at least 10″ long. This netting 2 will secure the flaccid or erect penis of the stallion; while at the same time allow him to urinate as needed. On one stiffening pad 1, on the side that is exposed, will be sewn at an angle that is to be determined, a nylon securing adjusting strap 4, with Velcro, or similar, fastening material on both ends of the strap. This securing adjusting strap 4 will overlap the stiffening pad 1 by at least 6″ and sewn to stiffening pad 1. This nylon adjusting strap 4 will be at least 2″ in width and at least 35″ in length. An extra pad 5 will be provided for extra protection for the horse's body. Slots will be cut in the extra pad 5 allowing the securing strap 4 to be inserted through the pad 5 so that the extra pad 5 will be between the securing strap 4 and the body of the horse. This extra pad 5 will be constructed of fiber padding material. It will be at least 4″ wide and at least 18″ long. On the other stiffening pad 1, on the side that will be exposed, will be sewn a nylon securing strap 7 with a plastic or nylon buckle 8 secured to the end of the strap 7. This strap 7 will serve as the securing strap to hold The Horse Jock securely in place. This nylon securing strap 7 will be at least 2″ in width and at least 6″ in length. Securing strap 7 will be sewn to the stiffening pad 1. Seams 9 made of cloth or nylon, or similar fabric seam material, will be sewn typically to stiffening pads 1.

1. What I, James William Draper, Jr., claim as my invention is The Horse Jock. The Horse Jock is an adjustable devise made of various types of fabric and flexible fiber board material that is intended to provide support for the exposed flaccid or erect penis of a male horse, while the stallion is being treated for paraphimosis. The Horse Jock is adjustable so that it can fit properly on any adult male horse. Its intended purpose is to support the flaccid or erect penis of the horse so that the chance of injury to the flaccid or erect penis is minimized while the stallion is being treated for the above mentioned condition.
